(19) United States
(12) Patent Application Publication
(10) Pub. No.: US 2024/0283146 A1
(43) Pub. Date: Aug. 22, 2024

(54) SPHERICAL REFLECTOR ANTENNA HAVING WAVEGUIDE FEED SYSTEM

(71) Applicant: Freefall Aerospace, Inc., Tucson, AZ (US)

(72) Inventors: Juan Carlos LOPEZ-TONAZZI, Tucson, AZ (US); Terrance PAT, Tucson, AZ (US)

(21) Appl. No.: 18/565,054

(22) PCT Filed: May 25, 2022
(86) PCT No.: PCT/US2022/030827

§ 371 Date: Nov. 28, 2023

Related U.S. Application Data
(60) Provisional application No. 63/194,524, filed on May 28, 2021.

(51) Int. Cl. H01Q 3/18; H01P 3/127; H01Q 1/12; H01Q 3/01; H01Q 3/08; H01Q 15/16

(52) U.S. Cl. CPC H01Q 3/18; H01P 3/127; H01Q 1/125; H01Q 3/01; H01Q 3/08; H01Q 15/16

(57) ABSTRACT

A spherical reflector antenna, comprising a spherical reflector having a reflective surface; a cylindrical waveguide line feed located along a focal line of the spherical reflector, the cylindrical waveguide having a plurality of axially spaced rings divided by radial fins, each axially spaced ring configured to have a plurality of radiating slots; and at least one sleeve that is detachably attached to the cylindrical waveguide to selectively vary antenna radiation patterns from the radiating slots.

### CROSS-REFERENCE TO RELATED APPLICATIONS

This application claims priority from U.S. Provisional Application No. 63/194,524, filed May 28, 2021, titled SPHERICAL REFLECTOR ANTENNA HAVING WAVEGUIDE FEED SYSTEM, which is incorporated herein by reference in its entirety.

### TECHNICAL FIELD

The present subject matter relates to a spherical reflector antenna having a waveguide line feed system, more particularly, to a spherical reflector antenna having a waveguide line feed system that is capable of maximizing radio frequency efficiency at any elevation angle.

### BACKGROUND

High gain antennas have a number of military and civilian uses, including (secure or unsecure) point-to-point communication (to and from satellites, terrestrial devices, and stratospheric devices), synthetic aperture radar (SAR), planetary and astrophysics research, etc. In point-to-point communications applications, increasing antenna gain increases the data rates at frequencies of interest, allowing users to receive more data (e.g., higher resolution images) using devices with smaller antennas (e.g., portable and even handheld devices). In imaging applications, increasing antenna gain enables the SAR to capture images with higher resolution and better contrast (i.e., greater sensitivity) and allows higher resolution images to be transmitted in real time.

Antenna gain may be increased by increasing the diameter of the antenna. However, conventional large diameter antennas for tracking on mobile or fixed applications, often have complex steering mechanisms and, due to their mass and volume, require substantial power and are expensive to transport.

Antenna may be mounted on a vehicle (e.g., Humvee), surface watercraft, or aircraft (e.g., pilotless drone, manned aircraft, etc.). Additionally, buoyant antennas may be released from submarines to float to the surface of the water and establish contact with the target while tethered to the submarine. Ideally, an antenna should maintain contact with a target even as the position and/or orientation of the antenna changes.

Conventional parabolic antennas that are mechanically steered can be, to a limit, steered fast enough to correct for changes in the position and/or orientation of the antenna by paying a price in weight, power and overall cost. In order to maintain communication with a target as an antenna is disrupted, the conventional antennas may be used as low gain antennas with broad beams. Spreading out the antenna beam, however, reduces the amount of power delivered to the target, thereby reducing bandwidth. Additionally, in secure communications and clandestine operations, wide antenna beams are problematic because they are easier to detect and intercept.

Accordingly, there is a need for a high gain antenna that can establish and maintain contact with a target in fixed and mobile applications, retaining main beam pattern and sidelobes performance at any elevation angle, even when the position and/or orientation of the antenna changes.

### SUMMARY OF THE INVENTION

Accordingly, the present disclosure is directed to a spherical reflector antenna, which substantially improves the performance of related spherical reflector antennas.

An object of the present disclosure is to provide a spherical reflector antenna, which comprises a spherical reflector having a reflective surface; a cylindrical waveguide line feed located along a focal line of the spherical reflector, the cylindrical waveguide having a plurality of axially spaced rings divided by radial fins, each axially spaced ring configured to have a plurality of radiating slots; and at least one sleeve that is detachably attached to the cylindrical waveguide to selectively vary antenna radiation patterns from the radiating slots.

Another object of the present disclosure is to provide a waveguide line feed, which comprises a cylindrical waveguide having a plurality of axially spaced rings divided by radial fins, each axially spaced ring configured to have a plurality of radiating slots; and at least one sleeve that is detachably attached to the cylindrical waveguide to be rotatable so as to selectively vary a size and/or shape of at least one of the radiating slots.

Still another object is to provide a visor for a spherical reflector antenna, which comprises a first branch, a second branch, and a connecting member that connects the first and second branches, wherein the visor is configured to be detachably attached to a reflective surface and movable on the reflective surface of the spherical reflector in such a way that a spherical reflective area can be extended in a controlled manner.

The features and advantages of the present invention, as well as the structure and operation of various embodiments of the present invention, are described in detail below with reference to the accompanying drawings. The drawing figures depict one or more implementations in accord with the present teachings, by way of example only, not by way of limitation. In the figures, like reference numerals refer to the same or similar elements.

### BRIEF DESCRIPTION OF THE DRAWINGS

The features and advantages of the present invention, as well as the structure and operation of various embodiments of the present invention, are described in detail below with reference to the accompanying drawings. The drawing figures depict one or more implementations in accord with the present teachings, by way of example only, not by way of limitation. In the figures, like reference numerals refer to the same or similar elements.

FIG. 1 is a diagram schematically illustrating a spherical reflector antenna in accordance with one exemplary embodiment.

FIG. 2A is a perspective view of a spherical reflector of the spherical reflector antenna and FIG. 2B is a side view of the spherical reflector of the spherical reflector antenna in accordance with an exemplary embodiment.

FIGS. 3A to 3C are views schematically illustrating an exemplary waveguide feed system of a spherical reflector in accordance with an exemplary embodiment.

FIG. 4 is a perspective view schematically illustrating an exemplary configuration of a sleeve to be attached to a waveguide feed system in accordance with an exemplary embodiment.

FIGS. 5A and 5B are views schematically depicting an exemplary configuration in which a waveguide feed system is installed with the sleeve of FIG. 4 in accordance with an exemplary embodiment.

FIGS. 6A-6C are views schematically depicting an exemplary configuration of rotating the sleeve of FIG. 4 in accordance with another exemplary embodiment.

FIGS. 7A-7D are views schematically illustrating an exemplary configuration of a visor system/member that is attached to a spherical reflector in accordance with one exemplary embodiment.

FIG. 8A is a side view of a spherical reflector without using the visor member of FIG. 7, and FIG. 8B is a side view of a spherical reflector with the visor member of FIG. 7 in accordance with one exemplary embodiment.

FIG. 9A is a side view of a spherical reflector with a radome, and FIG. 9B is a perspective view of the spherical reflector with the radome in accordance with one exemplary embodiment.

FIG. 10 is a graph showing a simulation of using a spherical reflector without the visor.

FIG. 11 is a graph showing a simulation of using a spherical reflector with the visor.

FIG. 12 is a graph showing a comparison when the simulation of FIG. 10 and the simulation of FIG. 11 are superimposed.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuity have been described at a relatively high-level, without detail, in order to avoid unnecessarily obscuring aspects of the present teachings. Also, exemplary embodiments are set forth in detail with reference to the drawings, in which like reference numerals refer to like elements or steps throughout.

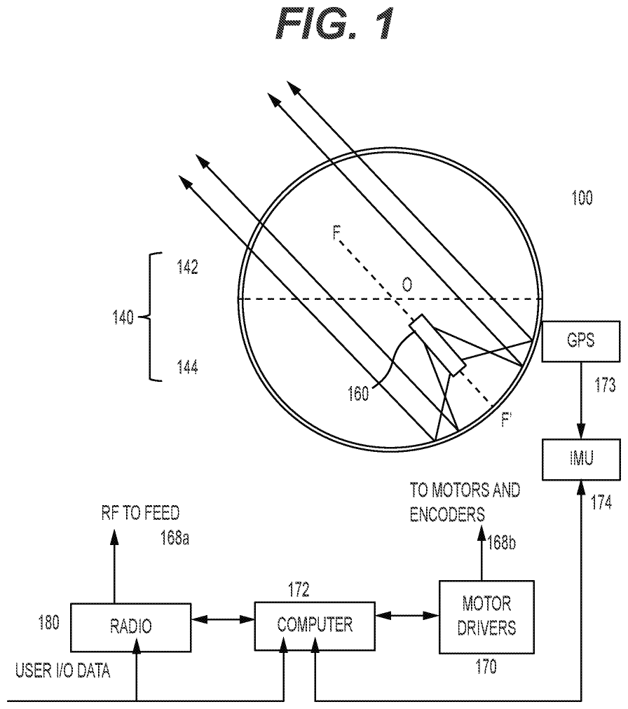

FIG. 1 is a diagram schematically illustrating a spherical reflector antenna 100 according to an exemplary embodiment. As shown in FIG. 1, the spherical reflector antenna 100 includes a spherical reflector 140, a feed system 160, mechanical beam steering electronics 170 (including motor drivers), and a radio 180.

The spherical reflector 140 includes a reflective surface 144. In one embodiment, as shown in FIG. 1, the spherical reflector 140 may further include a transparent surface 142 that is transparent to electromagnetic waves and is arranged facing the reflective surface 144. In other embodiments, as will be described later, the spherical reflector 140 may further include a radome (a flat radome 600 as shown in FIG. 9B) that is configured to cover the reflective surface 144 to prevent the spherical reflector 140 from being damaged. Alternatively, the spherical reflector 140 may be formed without a transparent surface, and also the spherical reflector 140 may be formed without a radome.

The mechanical beam steering electronics 170 may be connected to a computer 172. When the spherical reflector antenna 100 transmits a signal, the signal is emitted by the feed system 160 and encounters the reflective surface 144, which directs the signal through the transparent surface 142 or the radome 600 in case that the transparent surface 142 or the radome 600 is used by the spherical reflector 140. When the spherical reflector antenna 100 receives a signal, the signal passes through the transparent surface 142 or the radome 600 in case that the transparent surface 142 or the radome 600 is used by the spherical reflector 140, and encounters the reflective surface 144, which focuses the signal into the feed system 160.

The feed system 160 may be any suitable device that receives electromagnetic waves that are reflected off the reflective surface 144 or emits electromagnetic waves that are reflected off the reflective surface 144. For example, the feed system 160 may include one or more line feeds. The line feed may be a pivoting line feed, an electronically steerable line feed, a collapsible line feed, etc. In one embodiment described in detail below, the feed system 160 includes a waveguide line feed. The waveguide line feed extends along one of the infinite focal lines like FF′ of the spherical reflector 140, and its position and extension on the line are such that the collection of reflected radiation (or the illumination of the reflector) is maximized and the sidelobes minimized.

The mechanical beam steering electronics 170 include motor drivers, and control the motor drivers that pivot the feed in elevation and rotate the feed in azimuth. The mechanical beam steering electronics 170 receive correction data from the computer 172, send positioning data (encoders) of the motor drivers to the computer 172 and send appropriate corrective signals to the motor drivers to enable rapid real-time correction for antenna disturbances due to wind, waves, vehicle motion, or other reasons like changing the tracking target.

The computer 172 may be any suitable computing device which controls the mechanical beam steering electronics 170. In one embodiment, the computer 172 may include a processing unit (e.g., a central processing unit) and non-transitory computer readable storage media (e.g., a hard disk, solid state memory, etc.). The computer 172 may also include a global positioning satellite (GPS) receiver 173 and an inertial measurement unit (IMU) 174. The IMU 174 detects motion and provides beam pointing corrections at>100 Hz. The IMU 174 may be any electronic device that calculates the orientation of the spherical reflector 140 relative to the Earth's surface (e.g., pitch, roll and yaw). The IMU 174, for example, may use gyroscopes and/or a magnetometer to calculate the orientation of the spherical reflector 140.

The on-board GPS 173 continuously updates antenna position and orientation, and is provided with, for example, Two-Line Elements set (TLE) to provide satellite orbital location. Also, the computer 172 has a GUI that enables rapid selection of satellite for autonomous acquisition and tracking.

Using the position of the spherical reflector antenna 100 received from the GPS/IMU 173, 174, the CPU of the computer 172 calculates the beam angle towards the known location of a target relative to the orientation of the spherical reflector 140 received from the IMU 174. The computer 172 then sends correcting commands to the mechanical beam steering electronics 170 which, in turn, steers the feed toward the new direction.

The radio 180 may be any suitable electronic device that outputs rf signals to the feed system 160 for transmission and/or receives signals received by the feed system 160. The radio 180 outputs signals to the feed system 160 and receives signals from the feed system 160 via the one or more signal lines 168a. The one or more signal lines 168a may include, for example, one or more coaxial cables.

In one embodiment, the spherical reflector 140 may have a 1 meter diameter reflective surface 144 that yields a 2 degree beam at X-band frequencies (i.e., 8.0 to 12.0 gigahertz). At X-band frequencies, the support uplink and downlink data rates of the spherical reflector antenna 100 may be between 3 and 50 megabits per second (or more, depending on spherical reflector diameter and transmitter power) for Ethernet-like connections. In other embodiments, the sphere may be other sizes, from the size of a beach ball to up to 3 meters (for operating at 115 GHz in the W-band). In additional to X-band communications, the spherical reflector antenna 100 may provide high bandwidth communications at frequencies in the S-band to the W-band. Moreover, there is no limit to the maximum size of the sphere. Also, in principle there is no limit to the frequency band except for very high frequencies due to the fabrication of very small waveguide feeds.

The transparent surface 142 may be any material with a low absorption rate (e.g., less than 1 percent) and low refractive index at the wavelengths of interest. The reflective surface 144 may be any suitable material with high reflectivity at the wavelengths of interest. For example, the reflective surface 144 may be an approximately 0.5 micron (e.g., 0.5 micron±0.1 micron) metallic coating applied to the material that forms the transparent surface 142. The metallic coating is applied to an area on one hemisphere of the spherical reflector 140. The reflective surface 144 may be an entire hemisphere of the spherical reflector 140 opposite the transparent surface 142 or less. The metallic coating may be applied to the inside surface of the spherical reflector 140 to form the reflective surface 144. If the transparent surface 142 is thin (as well as transparent), the metallic coating may be applied to the outside surface of the spherical reflector 140 to form the reflective surface 144.

In most embodiments, in order to overcome some of the problems with prior art inflatable antennas, the spherical reflector 140 may be rigid. In limited instances, however, it may be beneficial for the spherical reflector 140 to be collapsible or inflatable so that the spherical reflector antenna 100 can be stowed or deflated and carried in a small package. In collapsible and inflatable embodiments, the transparent surface 142, if provided, may be a flexible polymer such as an approximately 0.5 mil thick Mylar skin (e.g., a 0.5 mil±1 mil Mylar skin). An inflatable spherical reflector 140 may be inflated using a pump or even by mouth. The feed system 160 of a spherical reflector antenna 100 with a collapsible spherical reflector 140 may also be collapsible together with its support structure. The inflatable spherical reflector 140 may also include one or more dielectric support curtains to keep the spherical shape.

The reflective surface 144 may be contiguous or substantially contiguous. For ground-based applications, including applications where the spherical reflector antenna 100 is mounted on a vehicle or watercraft or floats on the surface of a body of water, the transparent surface 142, if provided, may be the top hemisphere of the spherical reflector 140 and the reflective surface 144 may be the bottom hemisphere. In those applications, the feed system 160 may extend in part along a focal line of the spherical reflector 140, or along one or more radial lines towards the hemisphere. For that reason, the feed system 160 is described below as extending toward the hemisphere or ground. However, the spherical reflector 140 may be oriented in any direction, especially in aerial and stratospheric applications.

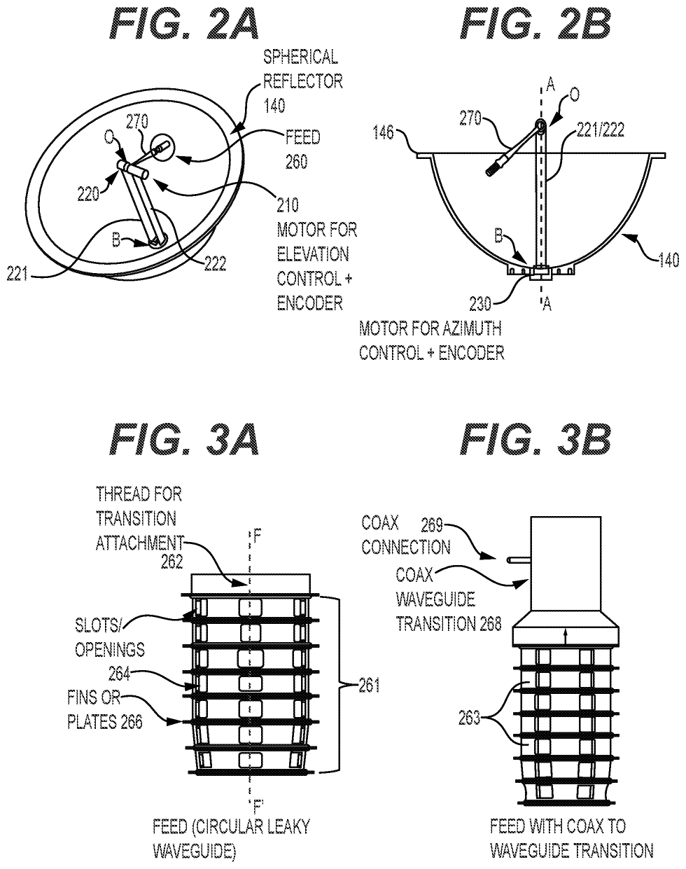

FIG. 2A is a perspective view schematically illustrating an exemplary antenna system in accordance with an exemplary embodiment, and FIG. 2B is a side view schematically illustrating the exemplary antenna system in accordance with the exemplary embodiment. As shown in FIGS. 2A and 2B, the antenna system includes a waveguide line feed 260 supported by a connecting member 270 extending from a center O of the spherical reflector 140, an elevation control motor 210 for positioning the waveguide line feed 260 at the desired elevation, and an azimuth motor 230 for positioning the waveguide line feed 260 in an azimuth plane (azimuth movement) and controlling the azimuth movement of the waveguide line feed 260. The elevation motor 210 may include an elevation encoder (first encoder) which can detect and convert the elevation movement/motion of the waveguide line feed 260 to an analog or digital coded output signal. The azimuth motor 230 may include an azimuth encoder (second encoder) which can detect and convert the azimuth movement/motion of the waveguide line feed 260 to an analog or digital coded output signal.

In one embodiment, a diameter of the spherical reflector 140 is approximately 10 times of the length of the waveguide line feed 260. For example, if the spherical reflector 140 has a diameter of 2 m, the waveguide line feed 260 may have a length range of 19 cm-20 cm (preferably a length of 19.7 cm) at Ka band. If the spherical reflector 140 has a diameter of 0.5 m, the waveguide line feed 260 may have a length range of 5 cm-6 cm (preferably a length of 5.6 cm).

In one embodiment, the waveguide line feed 260 has a maximum efficient feed design, and is configured to steer beam with a simple lightweight feed motion without pointing of the spherical reflector 140. By design, the waveguide line feed 260 is always on the axis line of the spherical reflector 140, and does not have gain drop with off-axis steering up to a certain elevation where the feeds illuminate part of the rim 146 of the reflector 140. Also, the waveguide line feed 260 is completely scalable to any gain/frequency, and has circular or linear polarization. Moreover, the waveguide line feed 260 has a bandwidth of 50%-60%.

In the case that the spherical reflector 140 has 0.5 diameter hemisphere and the waveguide line feed is 5.6 cm in length, the weight of the complete antenna system (including the spherical reflector 140 and other necessary elements) may be up to 30 lbs, and the waveguide line feed 260 has a center frequency of 35 GHz with the bandwidth (3 dB) of 59%. The waveguide line feed 260 may selectively use one or a combination of RHCP, LHCP and linear polarization. The spherical reflector antenna 100 with the waveguide line feed 260 may achieve an antenna gain larger than 40 dBi. The azimuth scan range is unlimited, and the elevation scan range is zenith to an angle dependent of the vertical extension of the reflector, the hemisphere being the maximum practical height. For a full hemisphere, Zenith to ˜30-35 degrees is achievable (30-35 degrees above horizon). Beyond that point, the gain decreases and the sidelobes increase.

In one embodiment, the feed system 160 also include a motorized mount 220, which may be located at the center O of the spherical reflector 140 which is configured to pivot the waveguide line feed 260 and hold/support the elevation motor 210. In one embodiment, as shown in FIG. 2A, the motorized mount 220 may include a pair of supporting bars 221 and 222 which extend from the center O to a rotating body through a boresight hole in the bottom area B of the reflective surface 144 and are parallel with a center axis AA (shown in FIG. 2B) of the spherical reflector 140. Alternatively, the motorized mount 220 may include a single supporting bar that extends from the center O to the bottom area B of the reflective surface 144 along the center axis AA. The length of each of the supporting bars 221 and 222 is substantially the same as the radius of the spherical reflector 144. In case that the single bar is employed, the height thereof is also substantially equivalent to the radius of the spherical reflector 140 and has a shape such that it doesn't interfere with the movement of the feed (for example a C-clamp shape. In another embodiment, the feed support structure may be position from the rim 146 of the reflector 140. The supporting bars may be hollow providing means to route the rf cables and the motor cables.

As shown in FIG. 2B, the azimuth motor 230 may be mounted beneath the bottom area B of the spherical reflector 140. The motorized mount 220 has one end portion (upper end portion in this embodiment) connected to the elevation motor 210 and the other end portion (the lower end portion in this embodiment) connected to the azimuth motor 230. The motorized mount 220 including the pair of supporting bars 221 and 222 may be made of metal or preferably of a material which is transparent to radio frequency (RF). Such a material may include, but not limited to, PTFE (Teflon), Plexiglass, Polyethylene, Polycarbonate and conjugated polymers in general.

The feed system 160 further includes the connecting member 270 that physically and electrically connects the waveguide line feed 260 with the motorized mount 220. The connecting member 270 may be shaped as a tapered tube and is also made of a material that is transparent to RF.

FIGS. 3A to 3C are views schematically illustrating the waveguide line feed 260 of the feed system 160 in accordance with an exemplary embodiment. As shown in FIG. 3A, the waveguide line feed 260 includes a cylindrical waveguide 261, and a thread portion 262 that is mounted on the top of the cylindrical waveguide 261 and is configured to be attached to a coax-to-waveguide transition part 268 (in FIG. 3B). As shown in FIG. 3B, the coax-to-waveguide transition part 268 serves as a middle member configured to connect the waveguide 261 to at least one coaxial cable. The coax-to-waveguide transition part 268 includes a coax connector 269.

Referring back to FIG. 1, the feed system 160 including the waveguide line feed 260 is located along a focal line FF′ of the spherical reflector 140. The cylindrical waveguide 261 of the waveguide line feed 260 is configured to illuminate efficiently the spherical reflector 140 during transmission the mechanical beam steering electronics 170 and in reception to efficiently collect the rf energy reflected by the sphere. In one embodiment, the cylindrical waveguide 261 includes a plurality of axially spaced rings 263 (in FIG. 3B) separated/divided by a plurality of radial fins/plates 266. Each axially spaced ring 263 is configured to have a plurality of radiating slots/openings 264. In one embodiment, the number of the radiating slots/openings 264 in each ring 263 may be six (6), and the shape of the radiating slots/openings 264 may be rectangular or square. However, the invention is not limited to six rectangular/square slots in each ring, such that the number of the slots/openings in each ring may be fewer than 6 or more than 6, the number of the slots in one ring may be different from the number of the slots in another ring, and the slots/openings may have triangle, circle, and/or any other suitable geometric shapes, because the number, positions, shapes and orientations of the slots/openings may be varied based on a desired antenna radiation patterns to be produced by the spherical reflector antenna 100.

FIG. 3C shows a perspective view showing the waveguide 261 is circular in shape and tapered such that the radius of the circular waveguide 261 may be made to vary along its length so as to correct aberration. The invention is not limited to this configuration. A waveguide of the invention may be rectangular in shape or other suitable geometric shapes.

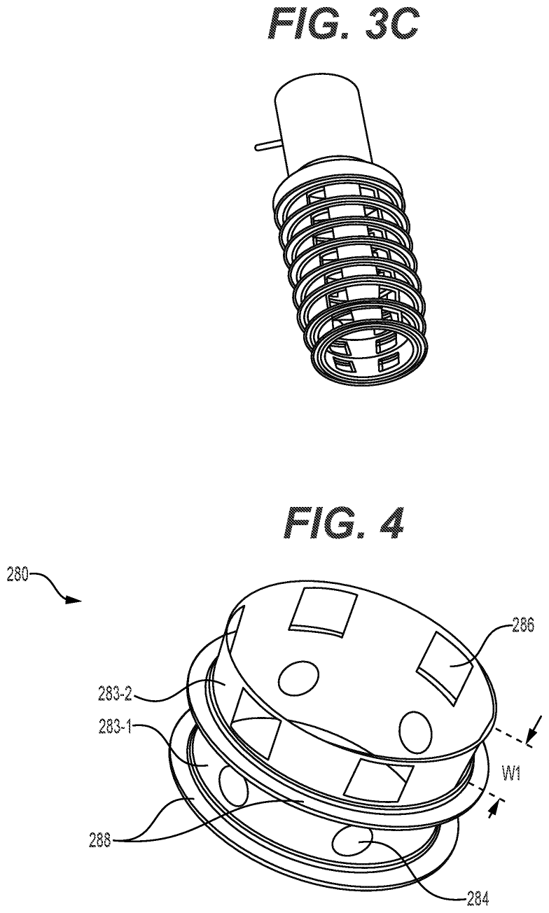

FIG. 4 is a perspective view schematically illustrating an exemplary configuration of a sleeve 280 attached to a waveguide line feed 260 in accordance with an exemplary embodiment. The sleeve 280 may be detachably attached to the cylindrical waveguide 261 to control the illumination of the reflector 140, which in turn affects sidelobes and/or overall antenna radiation patterns. In one embodiment, the sleeve 280 is configured to selectively vary the antenna radiation patterns (i.e. gain) by modifying the radiating slots 264. The sleeve 280 may be attached to an inside surface of the cylindrical waveguide 261. Also, the sleeve 280 may be attached to an outside surface of the cylindrical waveguide 261. The sleeve is configured to cover or surround at least one axially spaced ring 263.

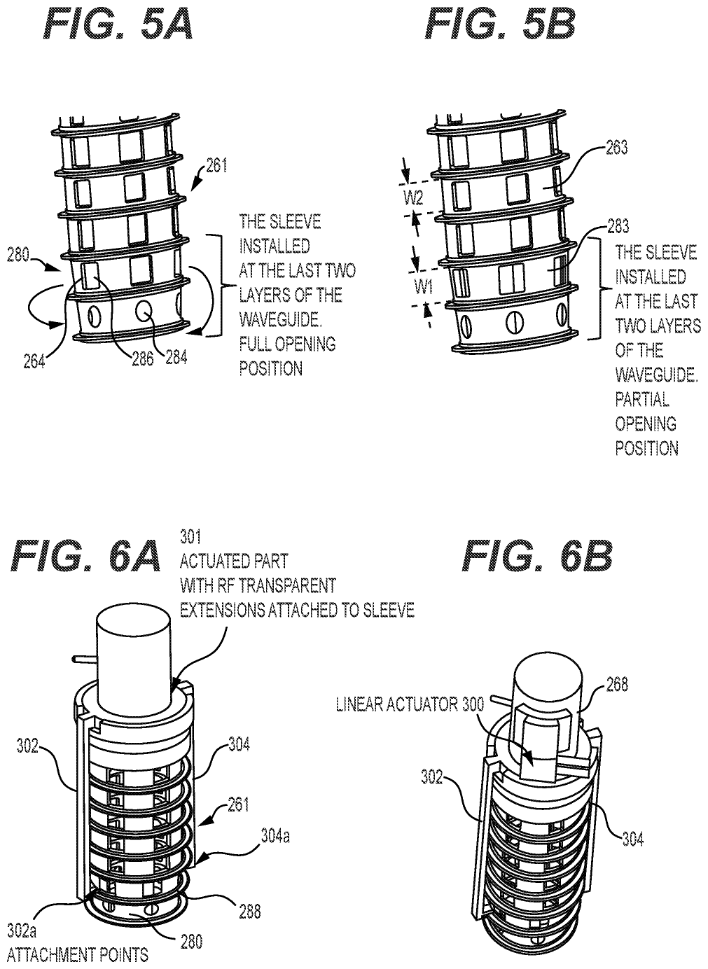

In one embodiment, the sleeve 280 may be detachably attached to the outside surface of the cylindrical waveguide 261. As shown in FIG. 4, the sleeve 280 includes two levels 283 (283-1 and 283-2), which are separated by sleeve-fins 288. In this embodiment, the upper level 283-2 may be formed with a plurality of square openings 286, and the lower level 283-1 may be formed with a plurality of circular openings 284. Each level 283 is positioned to cover and/or surround a corresponding ring 263 of the cylindrical waveguide 261. The level 283 has a width W1, which is designed to be substantially the same as a width W2 (in FIG. 5B) of the ring 263. The cylindrical waveguide fins are removed from the levels 283 where the sleeve 280 is going to be used. Thus, the sleeve 280 includes necessary fins 288 that replace the ones that are removed from the waveguide 261. In this case, the fins are incorporated into the sleeve. The number of the openings 284 in the level 283-1 and the number of the openings 286 in the level 283-2 are each set to be the same as the number of the slots 264 on each corresponding axially spaced ring 263. The openings 284 on the level 283-1 and the openings 286 on the level 283-2 are also positioned and orientated corresponding to the respective slots 264 of the respective rings 263.

The invention is not limited to the above configuration, and the sleeve of this invention may include at least one level or may include more than two levels, contiguous or not, and each level may have a plurality of openings that may be different in size, shape, position and orientation, which may be determined according to the antenna radiation patterns to be produced by the spherical reflector antenna 100. For example, the openings on each level may have different shapes, such as triangle, rectangular, circular, and/or other suitable geometric shapes, may have different sizes, and/or may positioned and aligned/oriented in different patterns. Moreover, the number of the openings on each level may be different from the number of the slots on the corresponding ring of the waveguide, but each opening on each level is positioned to be able to fully overlap with a corresponding one of the slots on the corresponding ring of the waveguide.

The sleeve 280 may have a radius that is slightly larger than the radius of the corresponding ring 263 if the sleeve 280 is attached to the outside surface of the ring 263, and may have a radius that is slightly smaller than the radius of the corresponding ring 263 if the sleeve 280 is attached to the inside surface of the ring 263. The sleeve 280 is made of a conductive material, which include, but not limited to, aluminum, copper, bronze, aluminized plastics, etc.

FIGS. 5A and 5B are views schematically depicting exemplary configurations in which the sleeve 280 is installed and attached to the outside surface of the cylindrical waveguide 261 in accordance with an exemplary embodiment.

FIG. 5A shows a first configuration in which the openings 284 and 286 of the sleeve 280 completely overlap the corresponding slots 264 of the cylindrical waveguide 261, respectively, so that the cylindrical waveguide 261 is in a full opening position. In one embodiment, the sizes of the openings 284 and 286 are designed slightly smaller than the respective sizes of the slots 264, and thus the openings 284 and 286 replace the overlapped slots 264 to serve/function as substitute radiating slots. Thus, the size, shape, and/or position/orientation of these substitute radiating slots of the sleeve 280 may selectively vary the antenna radiation patterns of the spherical reflector antenna 100.

FIG. 5B shows a second configuration in which the openings 284 and 286 of the sleeve 280 partially overlap the corresponding slots 264 of the cylindrical waveguide 261 so that the cylindrical waveguide 261 is in a partial opening position. As the sizes of the openings 284 and 286 are designed slightly smaller than the respective sizes of the slots 264, and thus the partially opened openings 284 and 286 replace the overlapped slots 264 to serve/function as substitute radiating slots. Thus, the size, shape, and/or position/orientation of these substitute radiating slots of the sleeve 280 may selectively vary the antenna radiation patterns of the spherical reflector antenna 100.

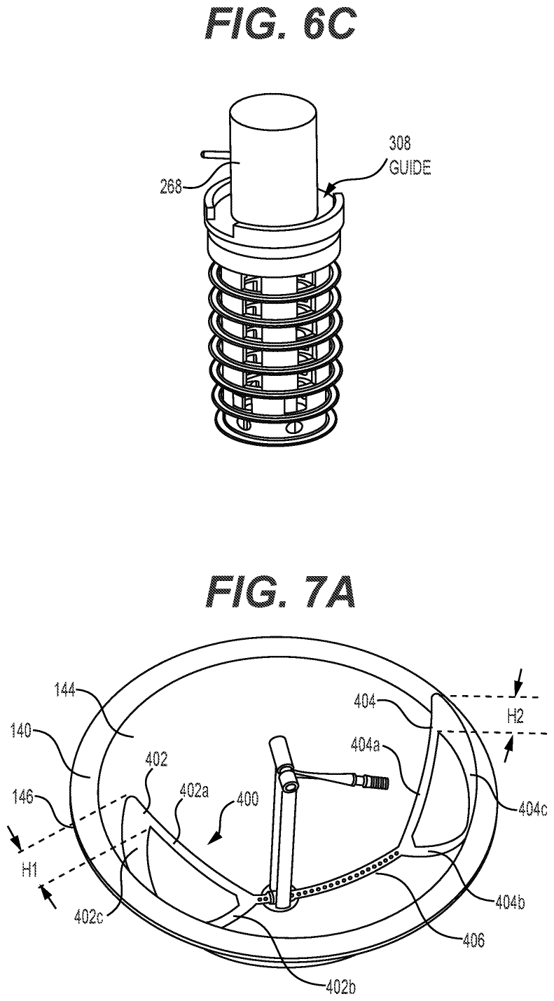

FIGS. 6A-6C are views schematically depicting an exemplary configuration of rotating the sleeve 280 of FIG. 4 with respect to the waveguide line feed 261 in accordance with one exemplary embodiment.

As shown in FIGS. 6A and 6B, the waveguide line feed 260 further includes a linear actuator 300 (in FIG. 6B) which is mounted on the top of the waveguide 261. The linear actuator 300 may be attached to the coax-to-waveguide transition part 268. The linear actuator 300 includes an actuated part 301 (in FIG. 6A) and a motor (or any driving device) that drives the actuated part 301. In one embodiment, the actuated part 301 has a ring shape that is sized to fit into a circular guide 308 (in FIG. 6C) formed around the coax-to-waveguide transition part 268, and includes at least one extension attached to the sleeve 280. In this embodiment, the extension may be formed with a pair of holding arms 302 and 304. The pair of holding arms 302 and 304 extend from the top of the waveguide 261 and is connected to at least one of the fins 288 of the sleeve 280. The ends of the holding arms 302 and 304 are each formed with a snap-fit mechanism that is snap-fit to the fin 288 of the sleeve 280 at attachment points 302a and 304a. Alternatively, the ends of the holding arms 302 and 304 may be detachably attached to the fin 288 of the sleeve 280 at attachment points 302a and 304a via any suitable attaching/holding mechanism.

The linear actuator 300 receive a control signal from the computer 172 (in FIG. 1) so as to activate the pair of holding arms 302 and 304 of the actuate part 301, thereby rotating the sleeve 280 a predetermined amount over a predetermined time, so that the waveguide 261 can be switched, at a predetermined speed, between the first configuration in which the sleeve 280 is in a fully opening position and the second configuration in which the sleeve 280 is in a partially opening position, thereby selectively varying the antenna radiation patterns of the spherical reflector antenna 100.

The holding arms 302 and 304 may be made of a RF transparent material, which includes, but not limited to, PTFE (Teflon), Plexiglass, Polyethylene, Polycarbonate and conjugated polymers in general.

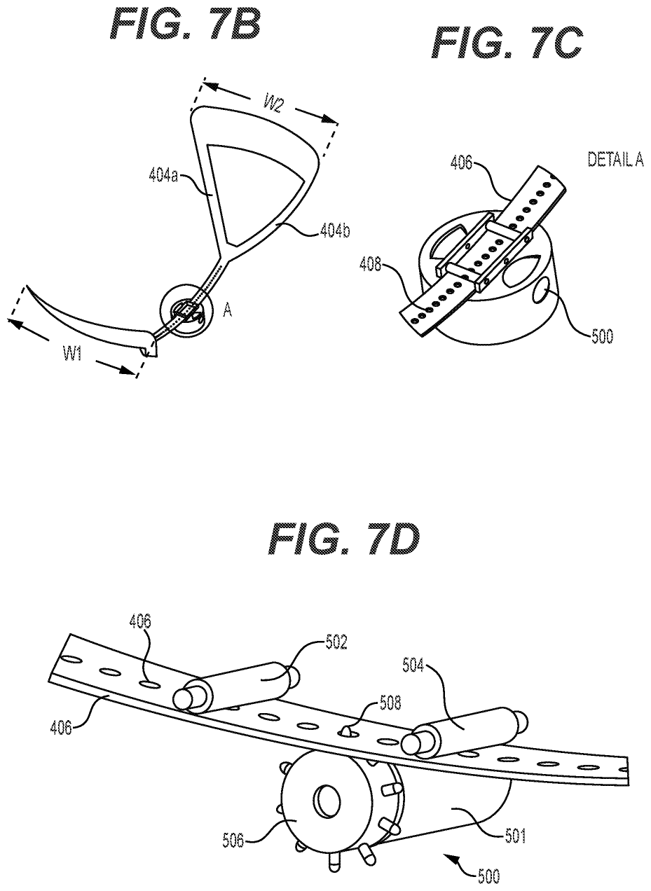

FIGS. 7A-7D are views schematically illustrating an exemplary configuration of a visor system/member 400 that is attached to a spherical reflector 140 in accordance with one exemplary embodiment.

As shown in FIG. 7A, the spherical reflector antenna 100 may further include the visor system/member 400 that may be detachably attached to the reflective surface 144. The visor system/member 400 may be made of a thin sheet of metal into the spherical shape of the spherical reflector 140, and is configured to be movable/slidable on the reflective surface 144 of the spherical reflector 140. In one embodiment, the visor system/member 400 may include a first branch 402, a second branch 404, and a moving member 406 that connects the first and second branches 402 and 404. As will be described in detail below, by moving the first branch 402 and/or second branch 404 beyond the rim 146 of the spherical reflector 140, the visor system/member 400 is able to extend a range of elevation of the spherical reflector antenna 100 without moving the spherical reflector 140. Since the visor system/member 400 and the waveguide line feed 260 have a small mass, they require small motors or actuators.

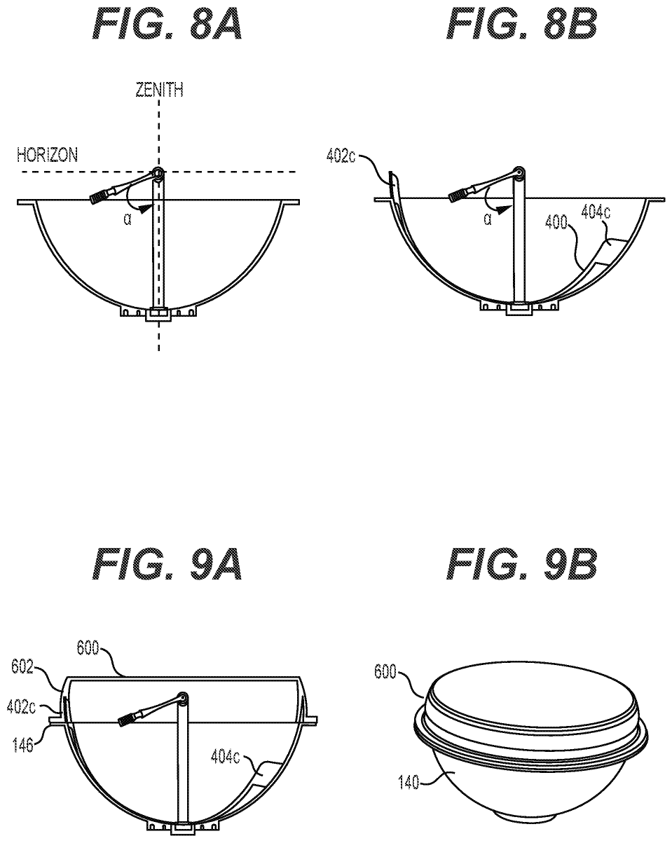

The first branch 402 is configured to be a first additional reflector, which includes a pair of arms 402a and 402b and a first reflective plate 402c that is supported by the pair of arms 402a and 402b. Each of the arms 402a and 402b has its one end connected to the first reflective plate 402c and the other end connected to the moving member 406. Alternatively, the first reflective plate 402c may be supported by a single arm (not shown). The first reflective plate 402c is an electrical conductor and serves as a reflector. The arms 402a and 402b are made of material that is conductive (if they are thin) or of a material transparent to RF such as PTFE (Teflon), Plexiglass, Polyethylene, Polycarbonate and conjugated polymers in general in which case they can be thicker. In the first case they should conform to the spherical surface 144 of the reflector 140. In the second case, it is preferred if they conform to the spherical reflector 140. The first reflective plate 402c may be a substantially rectangular shape, and have a height H1 that is set to a value so that the first reflective plate 402c is able to provide additional reflective area to the spherical reflector antenna without moving the spherical reflector 140 when the waveguide line feed 260 moves beyond a certain elevation as shown in FIG. 8B. The first reflective plate 402c may have a width W1 (in FIG. 7B) that is set to a value so that the first reflective plate 402c is able to cover a range of azimuth of the spherical reflector antenna without moving the spherical reflector 140 when the waveguide line feed 260 moves beyond the rim 146 as shown in FIG. 8B. The first reflective plate 402c may have a curvature that is the same as the curvature of the reflective surface 144. The first branch 402 may be made of material transparent to RF.

The second branch 404 is configured to be a second additional reflector on the opposite side to 402 to cover the elevation angles at opposite direction at the same azimuth. The second branch 404 includes a pair of arms 404a and 404b and a second reflective plate 404c that is supported by the pair of arms 404a and 404b. Each of the arms 404a and 404b has its one end connected to the second reflective plate 404c and the other end connected to the moving member 406. Alternatively, the second reflective plate 402c may be supported by a single arm (not shown). The second reflective plate 404c is an electrical conductor and serves as a reflector. The arms 404a and 404b are made of material chosen using the same criterion as 402a and 402b. The second reflective plate 404c may be a substantially rectangular shape, and have a height H2 that is set to a value so that the second reflective plate 402c is able to cover a range of elevation of the spherical reflector antenna without moving the spherical reflector 140 when the waveguide line feed 260 moves beyond a certain elevation as shown in FIG. 8B. The second reflective plate 404c may have a width W2 (in FIG. 7B) that is set to a value so that the second reflective plate 404c is able to cover a range of azimuth of the spherical reflector antenna without moving the spherical reflector 140 when the waveguide line feed 260 moves beyond the rim 146 as shown in FIG. 8B. The second reflective plate 404c may have a curvature that is the same as the curvature of the reflective surface 144.

In one embodiment, the height H1 may be the same as the height H2, and the width W1 may be the same as the width W2. Alternatively, the height H1 may be different from the height H2, and the width W1 may be different from the width W2.

In one embodiment, the first branch 402 and the second branch 404 may move together. Alternatively, the first branch 402 and the second branch 404 may move independently such that only one is moved at a time when necessary.

In one embodiment, the moving member 406 may be a chain that is operated by an actuator 500. As shown in FIG. 7C, the chain 406 includes a plurality of holes 408 for sprocket engagement with the actuator 500. As shown in FIG. 7D, the actuator 500 may include a motor 501 or, alternatively, a solenoid push-pull (no sprocket), a pair of press-down rollers 502 and 504, and a sprocket member 506. The motor 501 of the actuator 500 is activated, based on readings from the elevation encoder or software from a controller of the motor 501, when the waveguide line feed 260 is above a certain elevation. The sprocket member 506 includes a plurality of pins 508, each of which moves into a corresponding one of the holes 408 when the motor 501 is activated. The pair of press-down rollers 502 and 504 serve to prevent the pin 508 of the sprocket member 506 from coming out of the hole 408 of the moving member 406 during the sprocket engagement.

The invention is not limited to the above-noted two actuators—the motor 501 and the solenoid push-pull, and any suitable actuator may be applicable to the invention.

FIG. 8A shows a configuration that the waveguide line feed 260 of the spherical reflector 140 does not use the visor system/member 400 and FIG. 8B show a configuration that the waveguide line feed 260 of the spherical reflector 140 uses the visor system/member 400 according to one exemplary embodiment. In this exemplary embodiment, the spherical reflector 140 has a parent diameter of 0.5 meters. The hemisphere of the spherical reflector 140 is cut down in height 80% and the visor system/member 400 is moved above the edge of the rim 146 by 20 degrees of elevation. The lateral size of the visor covers 60 degrees in azimuth. As shown in FIG. 8B, when the waveguide line feed 260 moves beyond a certain elevation of the spherical reflector 140 (left side of FIG. 8B), the first reflective plate 402c of the visor system/member 400 is simultaneously moved above the edge of the rim 146 (left side of FIG. 8B) to serve as the first additional reflector, thereby maximizing radio frequency efficiency at any elevation angle.

While not shown, when the waveguide line feed 260 moves above a certain elevation to the right side of FIG. 8B, the second reflective plate 404c of the visor system/member 400 is also simultaneously moved above the edge of the rim 146 to the right side of FIG. 8B to serve as the second additional reflector, thereby maximizing radio frequency efficiency at any elevation angle.

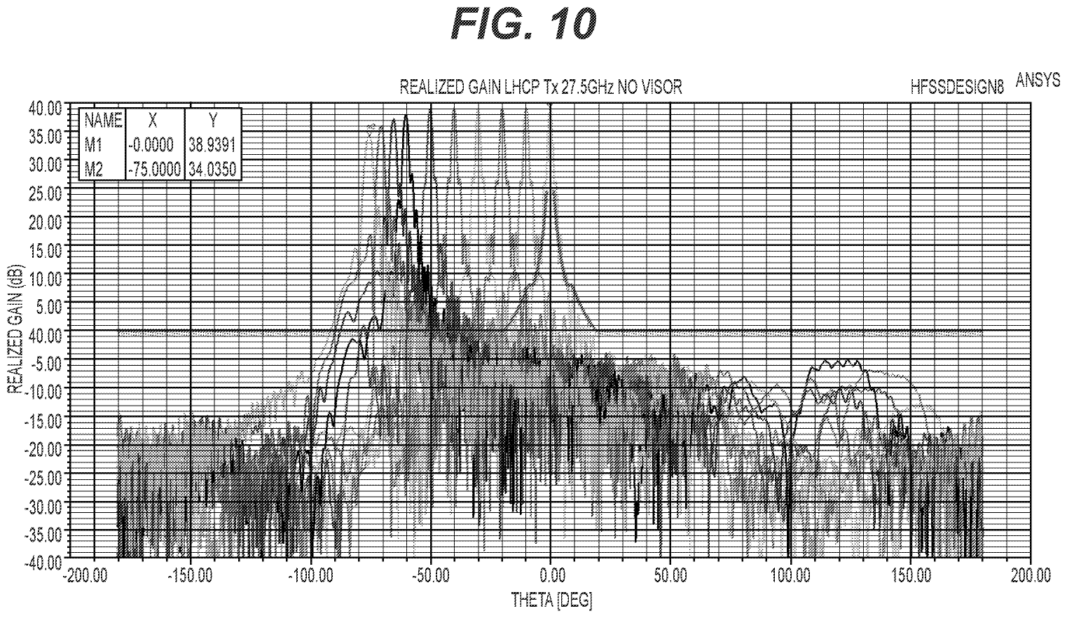

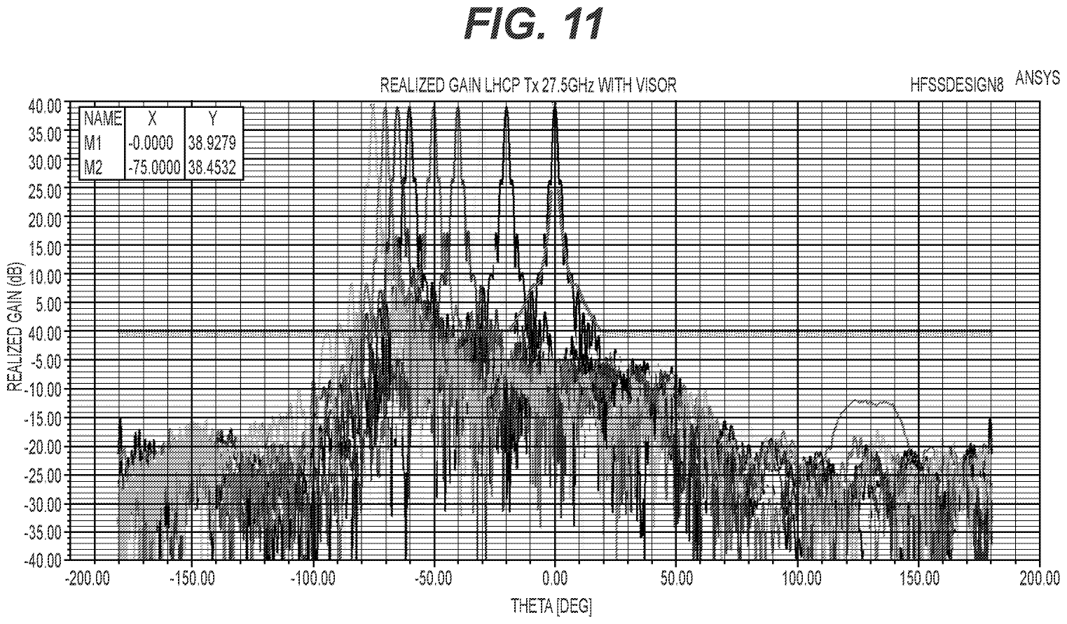

FIG. 10 shows a first simulation that is made using hfss software of the spherical reflector 140 of FIG. 8A, which does not use the visor system/member 400. FIG. 11 shows a second simulation that is made using hfss software of the spherical reflector 140 of FIG. 8B, which uses the visor system/member 400. The first simulation and the second simulation are made to prove the effectiveness of using the visor system/member 400.

FIG. 10 shows the radiation patterns for different elevations, from 0 degrees (boresight) to 75 degrees (15 degrees from horizon). The elevation is indicated in FIG. 8 as the angle α. The degradation in the main peak gain and sidelobes is shown as the waveguide line feed 260 moves to higher elevations in FIG. 8A, in which the visor system/member 400 is not used. In contrast, in FIG. 11, in which the visor system/member 400 is used, when the visor is up as shown in FIG. 8B, the radiation patterns remain constant for all practical purpose. In the first simulation, the gain drops by ˜5 dB. In the second simulation, the gain drops by only ˜0.4 dB.

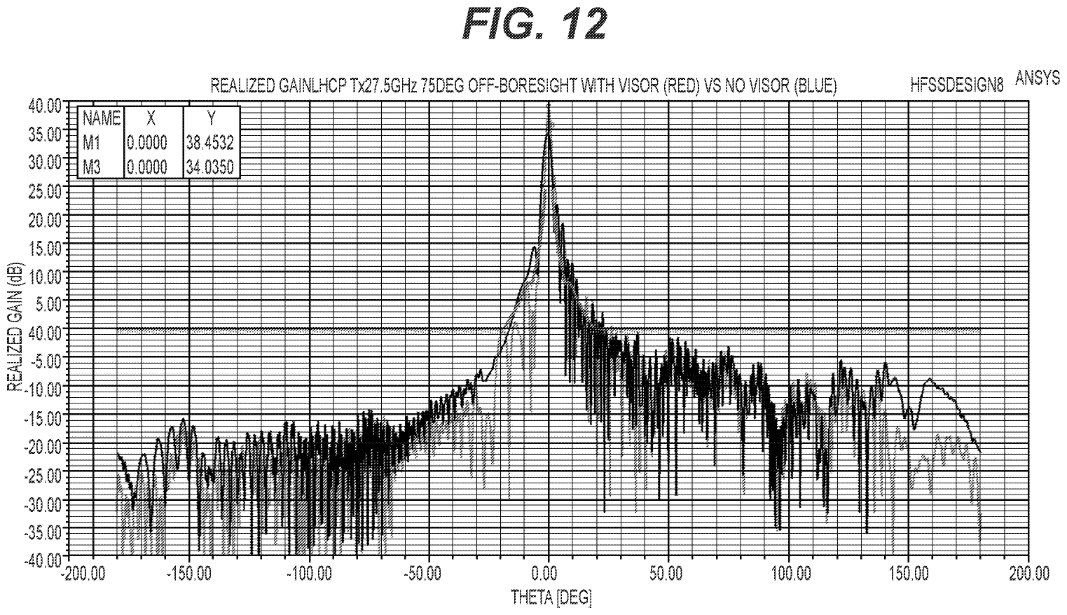

FIG. 12 shows a comparison at 75 degrees elevation of the radiation patterns by superimposing the cases with and without using the visor system/member 400.

FIG. 9A is a side view of a spherical reflector with a radome 600 and FIG. 9B is a perspective view of the spherical reflector with the radome 600 in accordance with another exemplary embodiment.

As shown in FIG. 9A, the radome 600 may include a cavity 602 formed around a peripheral area of the radome 600. The cavity 602 is sized and shaped to receive the first reflective plate 402c and/or the second reflective plate 404c when the first reflective plate 402c and/or the second reflective plate 404c move above the rim 146 of the spherical reflector 140.

As shown in FIG. 9B, the radome 600 has a flat shape, and is sized and shaped to cover the spherical reflector 140. The radome 600 is transparent to RF, and may be any material with a low absorption rate (e.g., less than 1 percent) at the wavelength of interest. The radome 600 may be any suitable material that transmits electromagnetic waves at the wavelength of interest.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims. It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “containing,” “contains,” “having,” “has,” “with,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as +10% from the stated amount. As used herein, the terms “substantially” or “approximately” mean the parameter value varies up to +10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. A spherical reflector antenna, comprising:
a spherical reflector having a reflective surface;
a cylindrical waveguide line feed located along a focal line of the spherical reflector, the cylindrical waveguide having a plurality of axially spaced rings divided by radial fins, each axially spaced ring configured to have a plurality of radiating slots; and
at least one sleeve that is detachably attached to the cylindrical waveguide to selectively vary antenna radiation patterns from the radiating slots.

2. The spherical reflector antenna according to claim 1, wherein the sleeve is attached to an outside surface of the cylindrical waveguide or an inside surface of the cylindrical waveguide.

3. (canceled)

4. The spherical reflector antenna according to claim 2, wherein the sleeve is configured to surround at least one axially spaced ring.

5. The spherical reflector antenna according to claim 4, wherein the sleeve includes a plurality of openings, the number of the openings is fewer than the number of radiating slots of the at least one axially spaced ring, and each of the openings is positioned to be able to fully overlap a corresponding one of the radiating slots.

6. The spherical reflector antenna according to claim 4, wherein the sleeve includes a plurality of openings corresponding to the plurality of radiating slots of the at least one axially spaced ring, respectively.

7. The spherical reflector antenna according to claim 6, wherein the plurality of openings of the sleeve are different from each other in size and/or shape.

8. The spherical reflector antenna according to claim 6, wherein the plurality of openings of the sleeve are different from the plurality of radiating slots in size and/or shape.

9. The spherical reflector antenna according to claim 7, wherein each of the radiating slots can be switched between a fully opening position and a partially opening position by rotating the sleeve a predetermined angular amount over a predetermined time, thereby varying the antenna radiation pattern.

10. The spherical reflector antenna according to claim 9, wherein the sleeve is held by at least one RF transparent arm positioned along the waveguide and configured to rotate the sleeve the predetermined amount over the predetermined time, thereby varying the radiation antenna patterns.

11. The spherical reflector antenna according to claim 1, further comprising:
a first motor/encoder for moving and controlling the waveguide line feed in an elevation direction;
a second motor/encoder for moving and controlling the waveguide line feed in an azimuth direction; and
a visor member detachably attached to the reflective surface and configured to move on the reflective surface of the spherical reflector, the visor member including a first branch, a second branch, and a connecting member that connects the first and second branches.

12. The spherical reflector antenna according to claim 11, wherein the first branch and the second branch are configured to move independently as a first additional reflector and a second additional reflector, respectively.

13. The spherical reflector antenna according to claim 11, wherein the first branch and the second branch are configured to move together as a first additional reflector and a second additional reflector, respectively.

14. The spherical reflector antenna according to claim 12, wherein the connecting member engages with a sprocket or gear member, thereby driving the first and second branches to make an elevation movement of the visor when the waveguide line feed is above a predetermined elevation in response to an elevation movement of the waveguide line feed.

15. The spherical reflector antenna according to claim 11, wherein the visor is made of a sheet of metal as a spherical shape that fits into the reflective surface of the spherical reflector.

16. The spherical reflector antenna according to claim 15, wherein the members driving the first and second branches are transparent to radio frequency (RF).

17. The spherical reflector antenna according to claim 11, wherein the visor is actuated by an actuator.

18. The spherical reflector antenna according to claim 17, wherein the actuator is controlled by a software program.

19. The spherical reflector antenna according to claim 11, further comprising a radome configured to cover the spherical reflector, wherein the radome includes a cavity that receives at least one of the first and second branches when the least one of the first and second branches move above a certain elevation.

20. The spherical reflector antenna according to claim 11, wherein the first branch includes a first arm member and a first reflective plate that is supported by the first arm member, and the second branch includes a second arm member and a second reflective plate that is supported by the second arm member.

21. A waveguide line feed, comprising:
a cylindrical waveguide having a plurality of axially spaced rings divided by radial fins, each axially spaced ring configured to have a plurality of radiating slots; and
at least one sleeve that is detachably attached to the cylindrical waveguide to be rotatable so as to selectively vary a size and/or shape of at least one of the radiating slots. 22-39. (canceled)

40. The spherical reflector antenna according to claim 8, wherein each of the radiating slots can be switched between a fully opening position and a partially opening position by rotating the sleeve a predetermined angular amount over a predetermined time, thereby varying the antenna radiation pattern.

41. The spherical reflector antenna according to claim 13, wherein the connecting member engages with a sprocket or gear member, thereby driving the first and second branches to make an elevation movement of the visor when the waveguide line feed is above a predetermined elevation in response to an elevation movement of the waveguide line feed.
